(19) United States
(12) Patent Application Publication
(10) Pub. No.: US 2018/0338644 A1
(43) Pub. Date: Nov. 29, 2018

(54) COOKING APPLIANCE WITH TEMPERATURE INDICATOR

(71) Applicant: Sunbeam Products, Inc., Boca Raton, FL (US)

(72) Inventors: Caleb Gossens, Portage, MI (US); Monica G. Lichty, Kalamazoo, MI (US); William Kennedy, Boca Raton, FL (US)

(21) Appl. No.: 15/987,312

(22) Filed: May 23, 2018

Related U.S. Application Data
(60) Provisional application No. 62/509,811, filed on May 23, 2017.

(51) Int. Cl. A47J 45/06; A47J 27/00; H05B 6/12; G01K 1/02; G01K 3/00

(52) U.S. Cl. CPC A47J 45/068; A47J 27/002; H05B 6/1209; G01K 2207/06; G01K 3/005; A47J 2202/00; G01K 1/02

(57) ABSTRACT

A cooking appliance having a temperature measuring device for selecting a pre-determined temperature appropriate for cooking a specific type of food product, the cooking appliance having a module selectively attachable to and removable from an end portion of the handle, the module including a plurality of selectable pre-determined temperatures and a signaling device for indicating to a user when the selected temperature has been reached, the temperature measuring device being coupled to the module through the handle.

### CROSS-REFERENCE TO RELATED APPLICATIONS

This application claims the benefit of U.S. Provisional Application No. 62/509,811, filed May 23, 2017, which is hereby incorporated by reference in its entirety.

### FIELD OF INVENTION

The present invention relates to a cooking appliance such as a pot, pan, skillet, griddle, grill or other cooking vessel and, more specifically, to a cooking appliance having a measurement device associated therewith to indicate when the cooking appliance has reach a desired temperature, the measurement device providing both an audio and visual alert system to notify the user of their attained temperature setting.

### BACKGROUND OF INVENTION

An issue with cooking appliances such as pots, pans, skillets, griddles, grills and the like is knowing when the cooking vessel is heated properly to begin cooking food. The reason why this is important is because if you place a food product into a pan or other cooking vessel before it is properly heated, the food product could stick to the surface of the vessel making it very difficult to move the food product around in the pan or vessel without damaging the food product. For example, chicken often sticks to the pan and if you try to turn the chicken over in the pan to cook the other side, the surface of the chicken adjacent to the pan often sticks to the pan and often times will peel away portions of the chicken as you rotate the chicken to its opposite side. This issue can also occur in pans or other vessels coated with Non-Stick coatings, though, in non-stick coated pans, once the pan has reached around 250° F., the Non-Stick coating begins to aid in releasing food surfaces that were previously sticking to the pan.

Another issue centers on when a chilled or cold food product is placed in a pan or other cooking vessel that is not preheated. When this occurs, it takes longer for the pan or vessel to heat and ingredients associated with the food product may release some of their moisture as they heat up, resulting in a dry cooked food product such as certain meats and vegetables. For example, steel expands as it heats and then contracts when it comes into contact with the relatively cooler meat product placed in the pan which, essentially at the surface microscopic level of the metal, will “bite” into the tissue of the meat product and cause sticking to occur. It is also taught in the culinary arts profession that raw proteins form molecular bonds with metal when an improperly heated pan comes into contact with that food product. Culinary professionals point out that the goal is to get the meat product to sear before it even comes into contact with the metal of the pan by heating oil hot enough so that it can sear the meat product in the time that it takes for it to pass from the air, through the film of oil, and into the pan. With a hot enough pan and the right material, just the heat of the air and the radiant heat of the pan itself may be enough to sear the meat product and avoid sticking.

Culinary professionals also point out that sticking most often happens with foods that have a lower fat content, such as skinless chicken and fish. One technique used by culinary professionals to prevent sticking and to optimize browning of your meat is to develop a nice “fond” on the pan. Fond is French for “base” or “foundation” and refers to the residue or particles of food remaining after meat and/or vegetables have been browned or cooked and is used to provide sauces and bases that will be added to other foods being made in order to enhance the taste with a deeper and richer flavor which also prevents the sticking of the food product.

Traditionally, users have used various techniques to indicate when the surface of the pan or other cooking vessel is thought to have achieved the appropriate temperature for beginning the cooking of a food product. Everything from carefully hovering one's hand over the pan's cooking surface to subjectively judge the surface temperature of the pan as it is heating up to placing butter or cooking oil or a few drops of water in the pan and observing the particular release agents' reaction as it is heating up to again estimate the surface temperature of the pan have been and currently are being used. The water droplet technique is one of the most often used and the observation of the water droplet reaction as it hits the pan falls into one of these three signals.
(1) If the water droplet streams, bubbles, and evaporates, the pan is too cold.
(2) If the water droplet forms a singular, “mercury-like” ball almost immediately that floats around the pan, with few to no smaller off-shoot balls, the pan is properly pre-heated.
(3) If the water droplet disperses immediately into many small “mercury-like” balls, the pan is too hot.

This technique for estimating the temperature of the pan is also based on research that came to be known as the “Leidenfrost Effect.” The Leidenfrost Effect is when a liquid in near contact with a mass significantly hotter than the liquid's boiling point, the liquid produces an insulating vapor layer keeping that liquid from boiling rapidly. This means that the liquid droplet will hover over the surface rather than making physical contact with it (Wikipedia.org-Leidenfrost Effect). At the proper temperature, a similar effect happens with the food product you place in the pan, preventing the food product from sticking. The Leidenfrost temperature point varies, around 193° C. (379° F.), but the Leidenfrost Effect is not necessarily ideal for food products that require lower cooking temperatures like eggs (250° F. to 300° F.), pancakes (320° F.) or French toast & vegetables (300° F.) because the higher temperature can burn or cook the specific food product in manners not desired for the final culinary result (i.e. for preparation of eggs—scrambled eggs, “sunny side-up” eggs, or “over-easy” eggs, and burning or browning the exterior surface may not be the desired intent for presentation and taste/texture consistency).

Thus, there is a need and it is therefore desirable to have a cooking appliance with electronics and a measurement device associated therewith wherein a user can select a desired cooking temperature and the measuring device will monitor the pre-heating of the cooking appliance and alert the user that the pre-selected cooking temperature has been achieved before the user actually places a food product in the cooking appliance. It is also desirable that the measurement device associated with the cooking appliance provide both an audio and a visual alert system to notify the user that the attained temperature setting has been achieved and that the electronics associated with the cooking appliance can be removed from the cooking vessel so that the appliance can be used in an oven and can be placed in a dishwasher for cleaning without damaging the electronics associated therewith. As a result, the present invention is directed to a cooking appliance with a temperature sensor indicator which overcomes one or more of the problems set forth above and represents an improvement over known cooking appliances.

### SUMMARY OF THE INVENTION

Disclosed herein is a cooking appliance with a temperature sensor indicator designed to indicate to a user when the cooking appliance has reached a pre-selected temperature. Non-inclusive examples of the cooking appliance may include pots, skillets, pans, griddles, grills, and the like. The cooking appliance may comprise a handle, an electronic module receivable within the handle, a temperature probe coupled to the electronic module, and a cooking vessel. The handle preferably includes a handle attachment member, a heat dissipating member, a handle end portion, and a handle tube. The handle attachment member is a bracket sized and shaped to mate with a side portion of the cooking vessel as will be explained in more detail later. The handle attachment member is adjacent and attached to the heat dissipating member. The heat dissipating member is a hollow V-shape member located and positioned in between the handle attachment member and the handle end portion and is specifically designed to dissipate heat generated by the cooking vessel so that the grip area of the handle is comfortable to the touch. The handle end portion is preferably a hollow elongated substantially cylindrical member which may be contoured for comfort and to better fit a person's hand when gripping the handle end portion and which is also configured to receive the electrical connections coupling the electronic module to the temperature probe as will be hereinafter explained in more detail. The handle tube is a hollow cylindrical member adjacent to and insertable within the handle end portion for receiving the electronic module. The handle attachment member, heat dissipating member, handle end portion, and handle tube may all be integrally formed to create the handle member. Alternatively, only part or none of the handle components may be integrally formed.

The electric module of the cooking appliance is selectively engageable with the handle tube. The module preferably includes two grooves of differing widths on an outer surface, while the handle tube preferably includes two pin members of differing sizes, each pin member sized to fit within a respective groove. The pin members are located within the interior portion of the handle tube so that the module may be inserted into the handle tube. Once inserted, the pin members of the handle tube are aligned with their corresponding grooves and the module is rotated to selectively secure the pin members within a corresponding keyed slot located at the end of each groove. This secures the module within the cooking appliance. The module may be removed from the handle by rotating the module in an opposite direction to disengage the pin members from within the respective slots.

In one embodiment, the module includes a printed circuit board, at least one battery, electronics for selecting a particular temperature appropriate for cooking a specific type of food product, electrical connections to supply power to the temperature measuring device, and at least one signaling device to show when the appropriate selected temperature has been reached. In one embodiment, the electronic module may provide both an audio and a visual alert system to notify the user when the attained temperature setting has been achieved. The electrical connections connect the at least one battery to the temperature measuring device located and positioned in the cooking vessel. The electrical connections extend from the temperature probe into and through at least one arm of the V-shaped heat dissipating member, through the handle end portion and the handle tube, before connecting to the electronics within the module thereby allowing the temperature measuring device to receive power and measure the temperature of the cooking vessel.

The cooking vessel may be any shape and size as long as it is able to hold and cook a food product. In one embodiment, the cooking vessel includes a three layer construction, namely, an induction plate, a temperature sleeve plate, and a vessel member. The three layers have a mating relationship that will be later described in more detail. The three layers are preferably secured together through conventional means such as through brazing, thereby preventing relative movement between the layers during assembly and use of the cooking appliance. The exterior face of the induction plate engages the burner or the stovetop, while the interior face of the induction plate has a mating relationship with the temperature sleeve plate. The temperature sleeve plate has a temperature sleeve cutout associated therewith extending from an edge of the temperature sleeve plate towards its center. The temperature sleeve cutout is sized and shaped to receive a temperature sleeve which is inserted into the temperature sleeve cutout, and preferably is an elongated hollow rectangular member configured to receive the temperature probe therewithin. The temperature sleeve plate is located and positioned in between the induction plate and the vessel member and has a mating relationship to the bottom of the vessel.

The cooking vessel includes appropriate attachment means for attaching the handle attachment member to the cooking vessel.

These and other aspects and advantages of the present cooking appliance will become apparent to those skilled in the art after considering the following detailed description in connection with the accompanying drawings.

### DESCRIPTION OF THE DRAWINGS

For a better understanding of the various embodiments of the present invention, reference may be made to the following accompanying drawings.

FIG. 1 is a top perspective view of a cooking appliance constructed according to the teachings of the present invention.

FIG. 2 is a bottom plan view of the cooking appliance of FIG. 1.

FIG. 3. is a bottom exploded perspective view of one embodiment of a handle associated with the cooking appliance of FIGS. 1 and 2.

FIG. 4 is a cross sectional view of the handle of FIG. 3.

FIG. 5 is a top perspective view of the handle of FIGS. 3 and 4 and the module of FIGS. 1 and 2 attached to the cooking vessel.

FIG. 6 is a top plan view of one embodiment of the module of FIGS. 1, 2, and 5.

FIG. 7 is an exploded perspective view of the module of FIG. 5.

FIG. 8 is a side elevational view of the module of FIGS. 6 and 7 connected to the electrical connections in the handle.

FIG. 9 is a side elevational view similar to FIG. 8 showing the interior of the module connected to the snap ring assembly which is positioned within the handle, the snap ring assembly being connected to the temperature probe.

FIG. 10 is an exploded bottom perspective view of one embodiment of the cooking vessel of FIGS. 1 and 2 showing the three layer construction.

FIG. 11 is a flow chart diagram of one embodiment of a startup procedure for the cooking appliance of FIGS. 1-9.

FIG. 12 is a flow chart diagram of one embodiment of the operation of the cooking appliance of FIGS. 1-9.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

The present invention will now be described with reference to the drawing figures in which like reference numerals refer to like parts throughout. For purposes of clarity in illustrating the characteristics of the present invention, proportional relationships of the elements have not necessarily been maintained in the drawing figures.

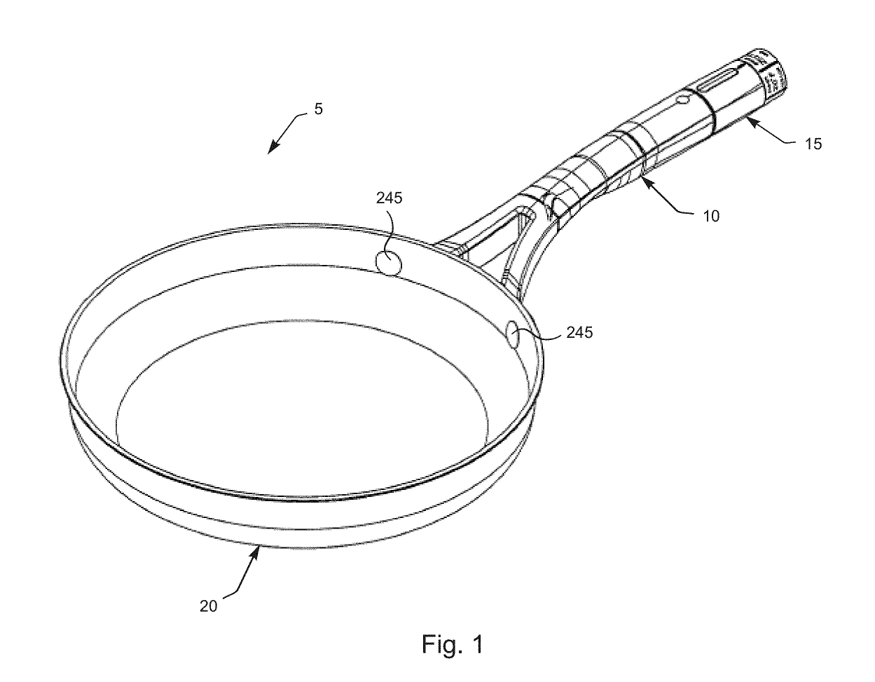

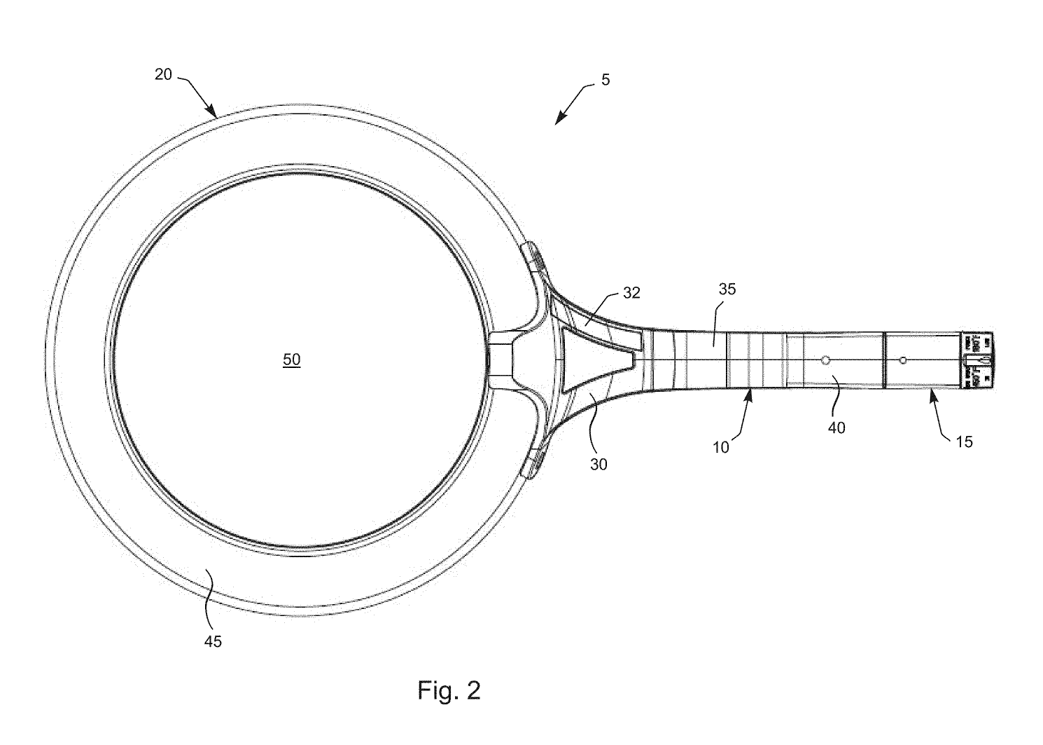

As illustrated in FIGS. 1 and 2, a cooking appliance 5 has been constructed in accordance with the teachings of one embodiment of the present invention and includes a handle 10, an electronic module 15, and a cooking vessel 20. The handle 10 is selectively engageable with the module 15 and is attached to the cooking vessel 20. The combination of the handle 10, module 15, and cooking vessel 20 allows a user to select a desired temperature appropriate for cooking a specific type of food product and the module will notify the user when the selected temperature has been reached. The selectively removable module 15 allows the user to place the cooking appliance 5 within an oven or dishwasher without destroying the electronics within the module 15.

The handle 10, in one embodiment, includes a handle attachment member 25, a heat dissipating member 30, a handle end portion 35, and a handle tube 40 as seen in FIGS. 2-4. The handle attachment member 25 is a bracket sized and shaped to mate with a side wall 45 of the cooking vessel 20. The handle attachment member 25 further extends from the side wall 45 of the cooking vessel 20 downwards towards an exterior bottom face 50 of the cooking vessel 20 as best seen in FIG. 2. The specific design of the handle attachment member 25 allows for that portion of the handle 10 to be easily re-designed to fit the various cooking vessel types while maintaining the same design for the other handle components where the module 15 engages the handle 10 as will be hereinafter further explained.

The handle attachment member 25 is likewise adjacent and attached to the heat dissipating member 30 which, in one embodiment, is a hollow V-shaped member. The V-shaped configuration of the heat dissipating member 30 allows the heat from the cooking vessel to more rapidly dissipate so that the actual grip area of the handle 10 is comfortable to the touch. The heat dissipating member 30 may also have a cover plate 32 preferably located and positioned on the underside of one or both of the arms of the V-shaped dissipating member, and may be any shape and size as long as it allows the user to access the hollow interior of the heat dissipating member 30, thereby providing access to the electrical connections 90 from a temperature measuring device 93 (e.g. a temperature probe) located in the cooking vessel 20. The electrical connections 90 extend from the temperature probe 93, through the heat dissipating member 30 and into the handle end portion 35. In this regard, the handle end portion 35 is also preferably a hollow elongated substantially cylindrical member which may be contoured ergonomically to be more comfortable for a user to grip handle end portion 35. Handle end portion 35 also receives electrical connections 90 from the temperature probe 93 which connections extend through handle end portion 35 to the module 15 which will be explained in more detail hereinafter. The handle tube 40 is a hollow substantially cylindrical member that may be inserted into the handle end portion 35 for making the connection with the module 15 as will be hereinafter further explained.

The handle attachment member 25, the heat dissipating member 30, the handle end portion 35, and the handle tube 40 are all preferably attached to each other, either mechanically using screws, press-fit fastening, or other mechanical means, by welding metal components together and, in alternative embodiments, the handle components may all be integrally formed together, or only some of the handle components may be integrally formed. Other methods of connecting the handle components known in the art are envisioned and foreseeable. The handle 10 could also be a two-piece assembly with a plastic molded insert for holding and electronically connecting different variations of the module 15. The handle 10 may also be polished to a “mirror-like” finish, or the finish could be modified to include a variety of other finishes (e.g. brushed, sandblasted, or plated) to create other colors and textures as desired.

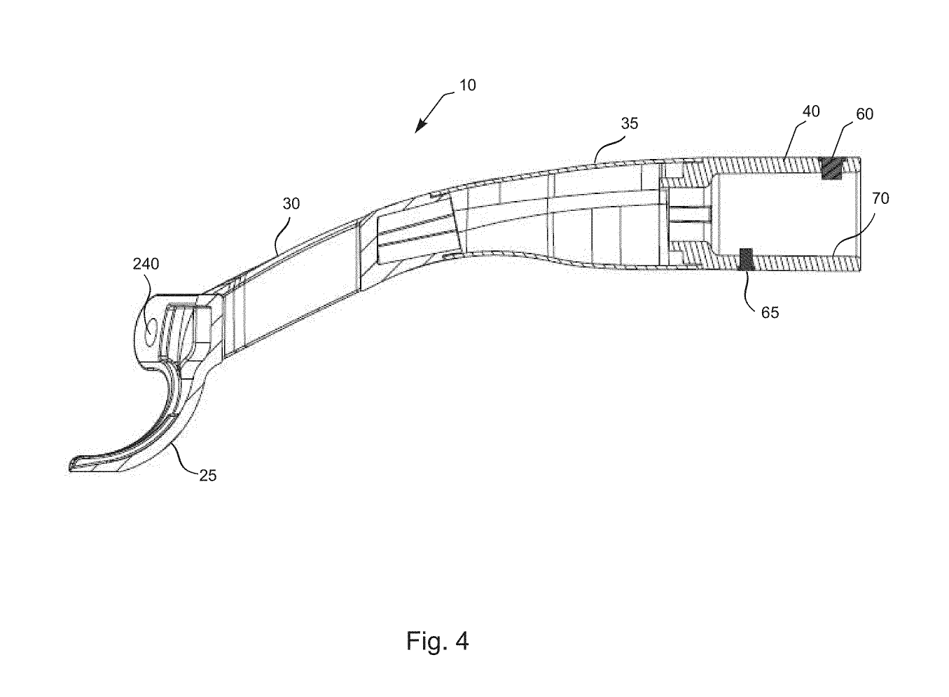

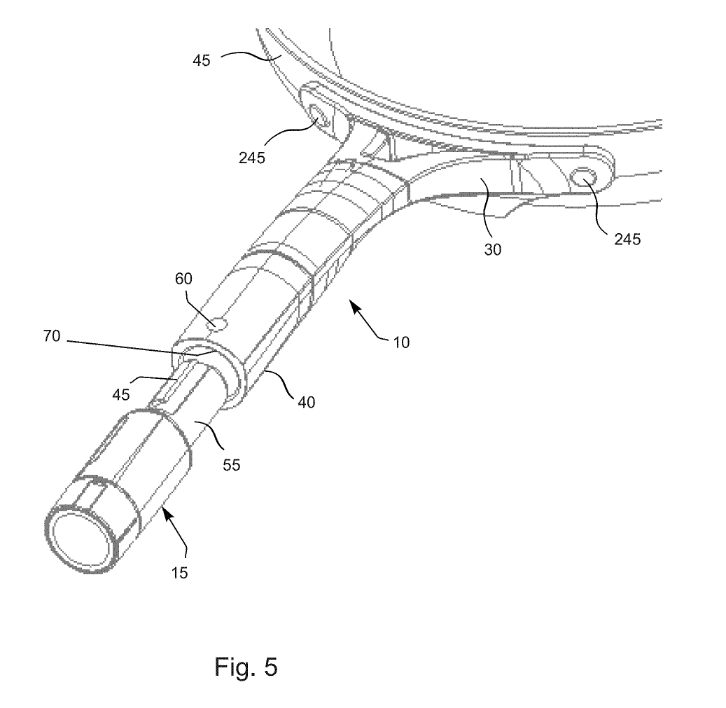

As illustrated in FIGS. 4, 5 and 6, the module 15 of the cooking appliance 5 is selectively engageable with the handle tube 40 of the handle 10. The module 15 preferably has a first groove 45 and a second groove 48, wherein both the first groove 45 and the second groove 48 are offset from each other and each contains a slot 68 at one end portion thereof for receiving the head of a respective first pin 60 and a second pin 65 (FIG. 4). The grooves 45 and 48 are preferably located opposite to one another on the outer surface 55 of the module 15. The first and second grooves 45 and 48 preferably are grooves of different widths that corresponding with the size of the first pin 60 and second pin 65 located and positioned on an inner surface 70 of the handle tube 40. The first pin 60 and the second pin 65 are sized and shaped to fit within its corresponding groove. The module 15 is positioned so that the first pin 60 and the second pin 65, in the handle tube 40, align with their corresponding grooves 45 and 48 on the module 15, and the module 15 is then inserted into the handle tube 40 until the pins 60 and 65 reach the end of the grooves 45 and 48 wherein the module is rotated so that the pins 60 and 65 slide into the respective slots 68. The module 15 therefore is able to selectively engage the handle tube 40. In order to remove the module 15 from the handle tube 40, the module 15 may be twisted or rotated in the opposite direction to slide pins 60 and 65 out of the slot portions 68 and into the grooves 45 and 48 where the module 15 can then be withdrawn from the handle tube 40. Thus, the module 15 is able to selectively engage the handle 10 of the cooking appliance 5 and therefore allow the cooking appliance 5 to be used in an oven or a dishwasher without destroying the electronics within the module 15 since it can be removed. The module 15 can further be removed to clean the module 15 or to replace the at least one battery 80.

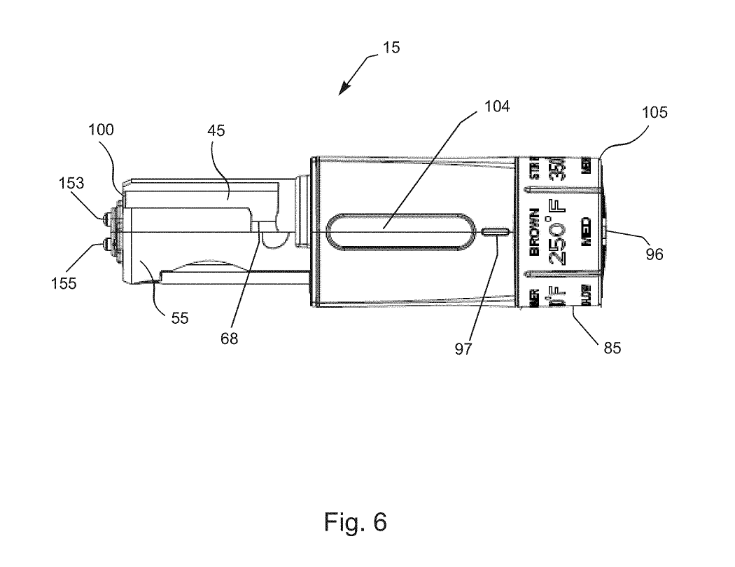

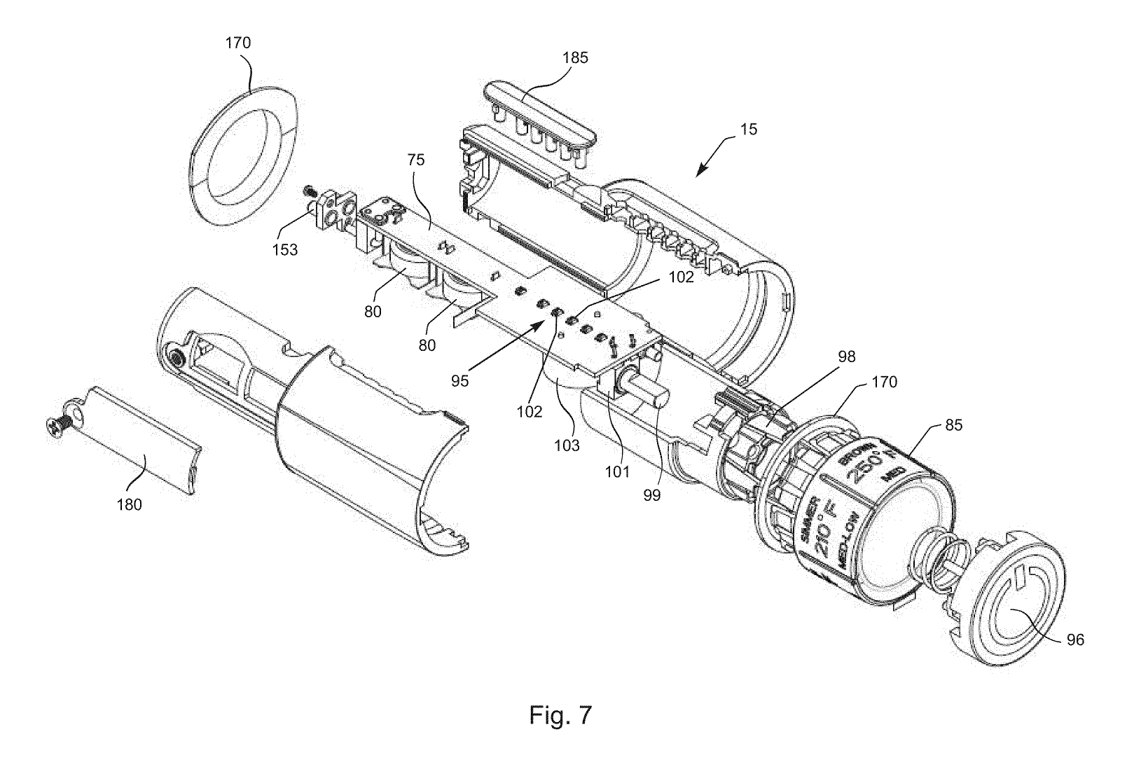

As best illustrated in FIG. 7, the module 15 includes at least one printed circuit board 75, at least one battery 80, electronics including a controller, a dial assembly 85 for selecting a particular temperature appropriate for cooking a specific type of food product, electrical connections 153 and 155 to supply power to the temperature measuring device 93, and at least one signaling device 95 to show when the appropriate temperature is reached. The module 15 includes a first end 100 and a second end 105 (FIG. 6), and further includes an on/off button or switch 96 preferably located and positioned at the second end 105 of the module 15 where the user can push the on/off button 96 to turn the power on or off. The dial 85 is preferably also located at the second end 105 of the module 15, adjacent to on/off switch 96, thereby allowing the user to select a particular temperature by rotating the dial 85 so that the desired temperature, indicated on the dial 85, aligns with the notch 97.

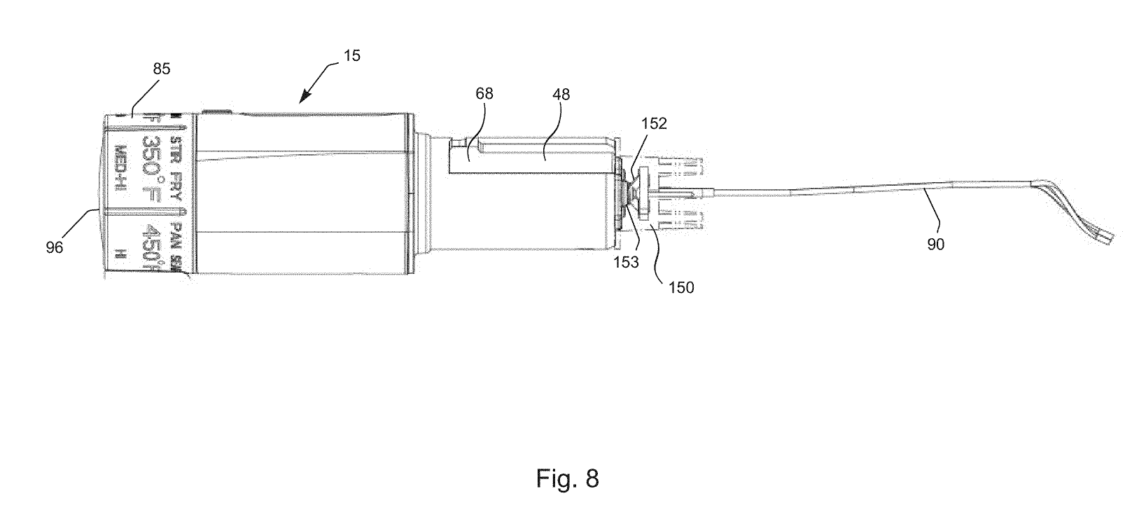

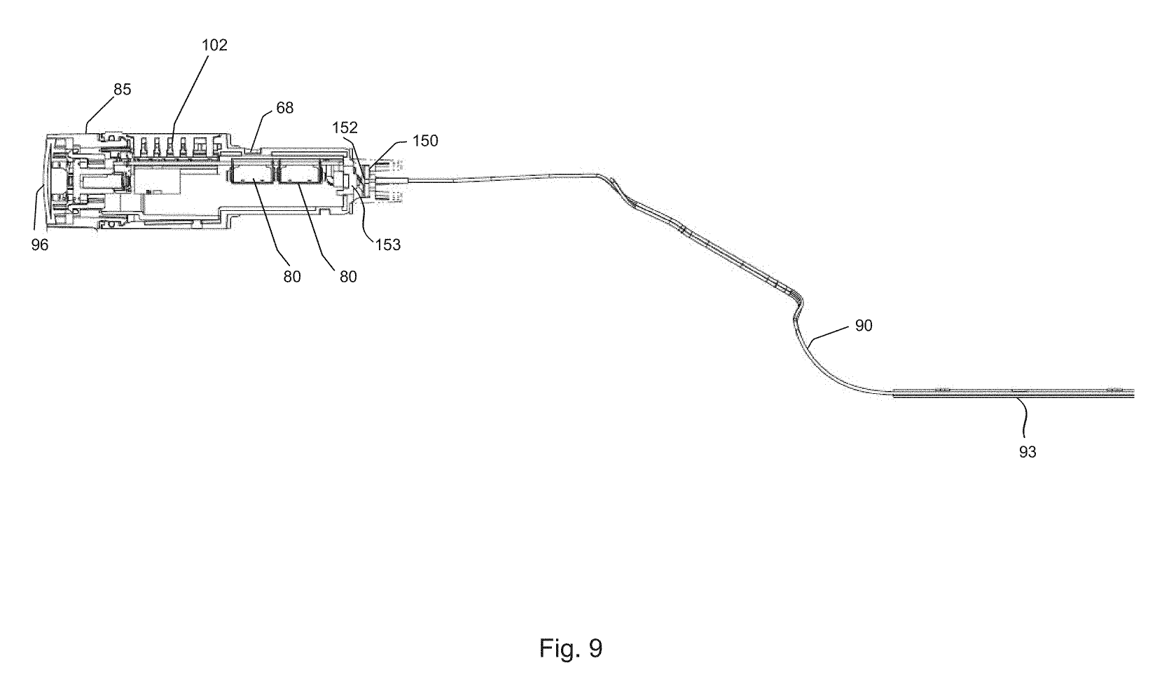

The electrical connections 153 and 155 are coupled to the at least one battery 80 for providing power to the temperature probe 93 within the cooking vessel 20. In this regard, electrical connections 90 extend from the temperature probe 93 into and through at least one arm of the V-shaped heat dissipating member 30, and through the handle end portion 35 and handle tube 40 before connecting to a snap ring assembly 150 which couples to the handle tube 40 as best shown in FIGS. 8 and 9. The snap ring assembly 150 includes electrical contacts 152 for engaging and coupling to the electrical connectors 153 and 155 of module 15 thereby providing power from the at least one battery to the temperature probe 93 as will be hereinafter further explained.

The module 15 also includes a rotary dial assembly 85 which is coupled to a shaft 99 associated with a potentiometer assembly 101 for selecting a pre-determined temperature as indicated on dial 85. When a user rotates dial 85, a dial actuator 98, which is coupled to both dial 85 and shaft 99, rotates shaft 99 and adjusts the potentiometer 101 to the selected temperature. This allows the signaling device 95 to know the desired selected temperature. Printed circuit board 75 which includes the controller then communicates the selected temperature to the temperature probe 93.

Once the module 15 has been turned on and the desired temperature selected, the module 15 will notify the user of the rate of the increase in temperature and when the desired temperature has been reached, or exceeded through at least one signaling device 95. The module 15 will also notify the user when an over heat condition exists at any selected temperature as will be hereinafter further explained. In one embodiment, the signaling device 95 of the module 15 may be visual indicators in the form of a series of LED lights 102 that preferably shows the heating progression as the temperature rises to the selected temperature and will indicate to the user when the selected temperature is reached. In one embodiment, the LED lights 102 may pulse or flash and then turn solid starting from the LED light closest to the user or closest to dial 85 and the LED lights will then progress to the top or to the furthest LED light showing the progression of the temperature to the selected temperature and, once the selected temperature has been reached, the top LED light may turn green notifying the user that the selected temperature has been reached. The series of LED lights 102 are visible through a window 104 (FIG. 6). The module may further indicate when the selected temperature has been exceeded and the cooking appliance 5 has been overheated by having the top LED light turn red. The signaling device 95 of the module 15 may also include an audio signaling device 103 such as a piezo buzzer which will emit a specific sound when the selected temperature is reached and/or when the cooking appliance 5 has overheated.

When the selectively engageable module 15 engages with the handle 10, the electrical connections 90 extend from the temperature measuring device or probe 93 through the handle 10 as previously explained to the snap ring connector assembly 150 located within the handle 10. The snap ring connector assembly 150 includes electrical connections 152 that mate with the module electrical connections 153 and 155 located within the module 15 to provide power to the temperature measuring device 93 within the cooking vessel 20. This mating of electrical connections 152, 153 and 155 allows the temperature measuring device 93 to receive power from the at least one battery 80 and measure the temperature of the cooking vessel 20. This also allows the module 15 and the controller associated therewith to receive signals from the temperature measuring device indicative of the temperature of the cooking vessel 20 as the vessel 20 heats up to the selected pre-determined temperature. The handle attachment member 20 covers the temperature measurement device 93 transition into the cooking vessel 20.

The module 15 further includes a pair of gasket 170 substantially encasing the components of the module 15 to minimize liquid infiltration. The gaskets 170 may be created through overmolding, although other methods are envisioned and foreseeable. The module 15 may further include a door 180 located and positioned over the at least one battery 80 thereby allowing a user to remove and change the at least one battery 80 when necessary. The door 180 may be any shape and size as long as it allows the user to remove and replace the at least one battery 80, and may be attached to the module 15 through a screw, although other methods are envisioned and foreseeable. The module may also include an escutcheon 185, which may be a substantially flat transparent plastic cover or shield located and positioned over the LED lights 102 to prevent the LED lights 102 from becoming damaged.

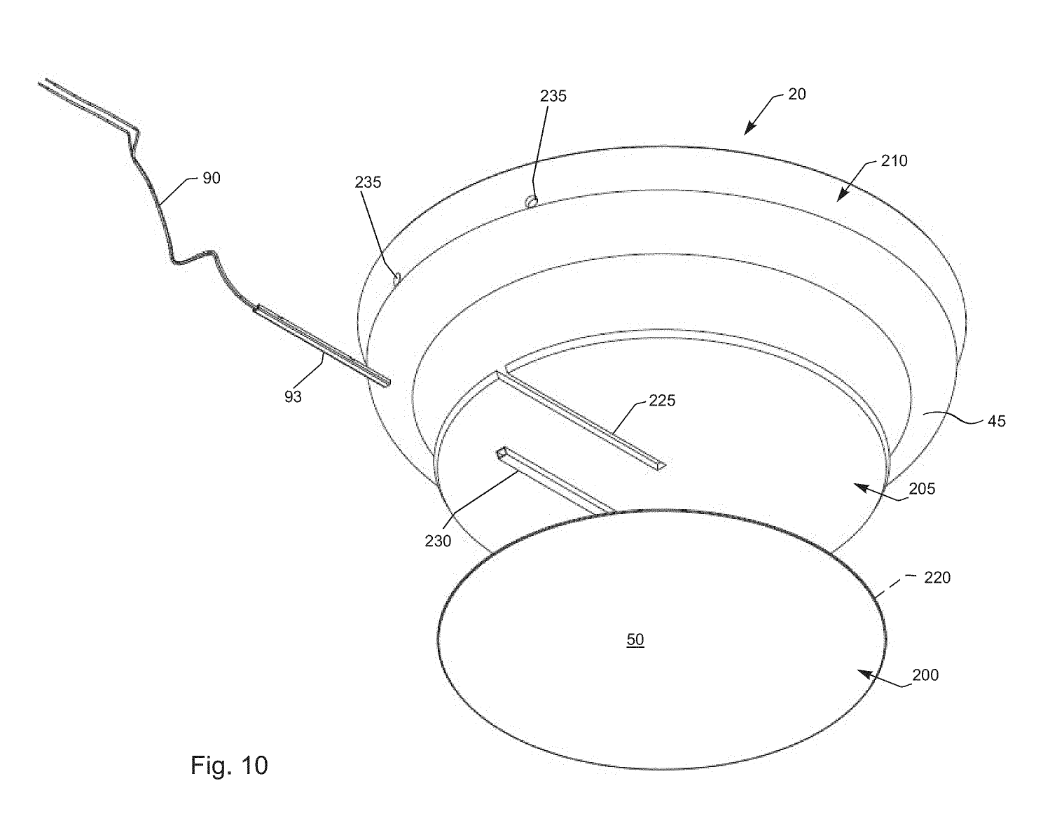

The cooking vessel 20 may be any shape and size as long as it is able to hold and cook food products and, in one embodiment, includes a three layer construction, namely, an induction plate 200, a temperature sleeve plate 205, and a vessel member 210. The three layers are preferably secured together through conventional means such as through brazing thereby preventing relative movement between the layers during assembly and use of the cooking appliance. The exterior face 50 of the induction plate 200 engages the burner or the stovetop, while the interior face 220 of the induction plate has a mating relationship with the temperature sleeve plate 205 as best illustrated in FIG. 10. The temperature sleeve plate 205 has a temperature sleeve cutout 225 that may extend from the edge of temperature sleeve plate 205 towards its center. The temperature sleeve cutout 225 is sized and shaped for receiving a temperature sleeve 230, the temperature sleeve 230 being inserted into the temperature sleeve cutout 225. In one embodiment, the sleeve 230 is an elongated hollow rectangular member configured to receive the temperature measuring device 93 therewithin. In other embodiments, the temperature sleeve cutout 225 may be positioned at other locations and may be configured differently as long as the temperature sleeve 230, the cutout 225 and the temperature measuring device or probe 93 are all compatibly configured such that the sleeve 230 is insertable into the temperature sleeve cutout 225 and the temperature probe 93 is insertable into the temperature sleeve 230. The temperature sleeve plate 205 is located and positioned in between the induction plate 200 and the vessel member 210 and has a mating relationship with both the induction plate 200 and vessel member 210 as illustrated in FIG. 10.

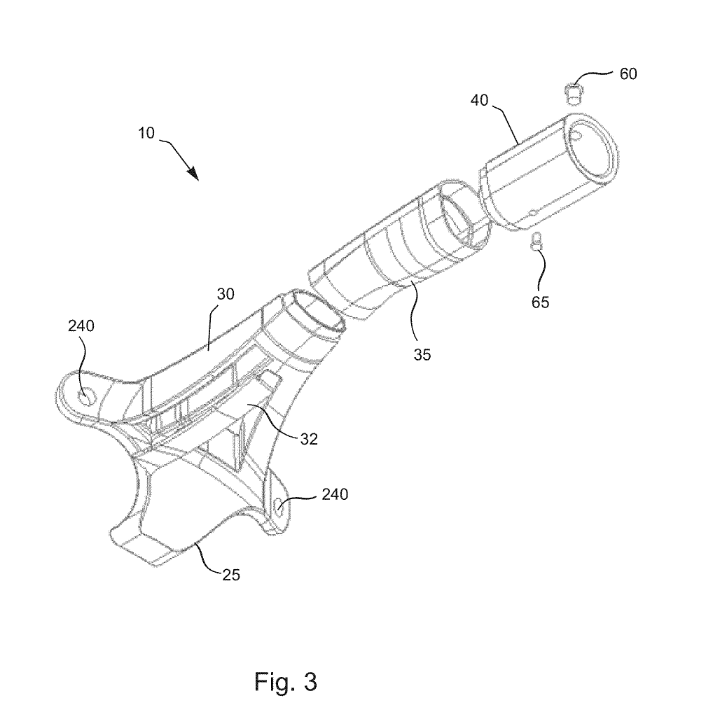

The vessel member 210 includes at least one vessel aperture 235 located and positioned on the vessel side wall 45 and the handle attachment member 25 also includes at least one handle aperture 240 (FIG. 3) that may be used to attach the handle 10 to the vessel member 210 though at least one rivet 245 (FIG. 1), although other methods of attachments are envisioned and foreseeable.

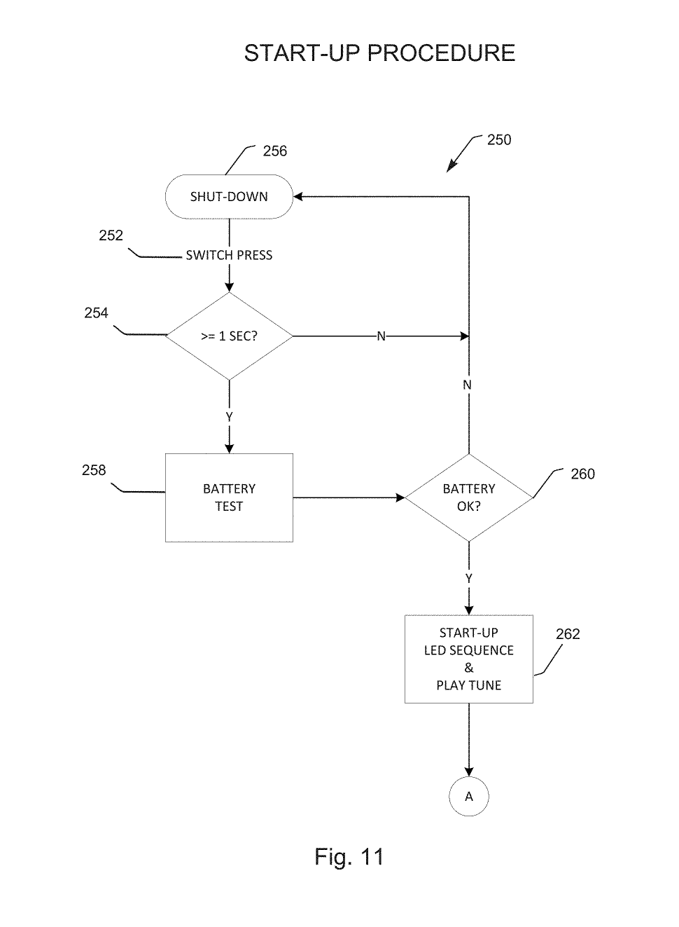

FIG. 11 is a flow chart diagram 250 of one embodiment of a startup procedure for operation of the cooking appliance 5 once the on/off switch 96 associated with module 15 has been activated. Once the on/off switch 96 is pressed at step 252, the controller associated with the module 15 will check to see if the on/off switch 96 has been pressed and held for at least one second at step 254. If the on/off switch 96 is not held for at least one second or some other pre-determined time period, the controller will return to the shutdown mode at step 256. If, on the other hand, the on/off switch 96 has been held for at least one second, the controller will then conduct a battery test at step 258. This battery test may, in one embodiment, be centered around at least a voltage of 2.2 volts. In other words, if the battery checks out to have a voltage of greater than 2.2 volts, the battery is considered okay and a green light may be activated on the module 15 to indicate that the battery is, in fact, okay. If, on the other hand, the battery test indicates that the voltage of the battery is less than 2.2 volts, a red light may appear on the module 15 indicating that the battery is not okay for operation. At step 260, the controller will determine if the battery is okay for operation. If the battery is not okay for operation in accordance with, for example, the one test embodiment explained above, the controller will progress back to step 256 and again shut down operation of the cooking appliance 5. If, on the other hand, the battery has been determined to be okay for operation at step 260, the controller will progress to step 262 where, in one embodiment, a start-up LED sequence through LED lights 102 and an audible alert through the piezo buzzer 103 may be activated to notify the user that the cooking appliance 5 is now ready for operation.

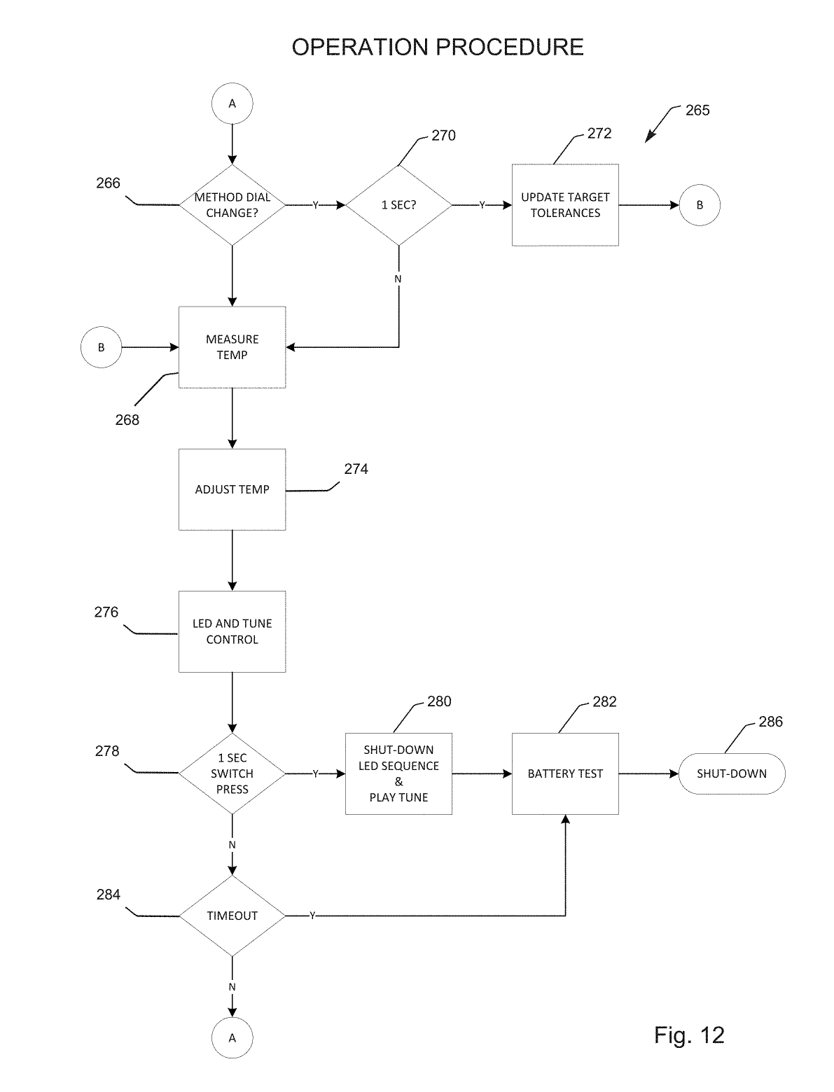

FIG. 12 is a flowchart diagram 265 of one embodiment of the operation of the present cooking appliance 5 once the startup procedure has been completed. Once the visual and audible alert has been given to the user that the present cooking appliance 5 is ready for operational use, the controller at step 266 looks to see if the temperature dial 85 has been rotated to one of the pre-selected temperatures for operating the cooking appliance 5. In one embodiment, for example, the pre-selected temperatures could include a poaching temperature of 160° F., a simmer temperature of 200° F., a browning temperature of 250° F., a stir-fry temperature of 350° F., and a pan sear temperature of 450° F. These temperatures can be selected by rotating the dial 85 to the appropriate temperature at step 266. If at step 266 no new temperature has been selected with dial 85, the controller will move to step 268 and begin to measure the temperature previously established with dial 85. If, on the other hand, a new temperature has been selected with dial 85 at step 266, the controller will check to make sure that this temperature selection remains set for at least one second, or some other pre-determined time, at step 270. If the temperature selected has not remained in a steady position for at least one second, the controller will revert back to step 268 and will continue to measure the temperature of the cooking appliance based upon the previously established temperature with dial 85. This one second delay, or any other pre-determined delay, can be inputted into the controller software to cover the situation where a user is rotating dial 85 through several different pre-selected temperatures in order to reach the desired temperature. If, at step 270, the temperature selected with dial 85 remains established for at least one second, the controller will, at step 272, update the target temperature and the established tolerances for that selected temperature and will return to step 268 to then measure and monitor the updated temperature target.

At step 268, the controller will continue to monitor and measure the temperature of the cooking vessel as compared to the selected temperature until the selected temperature is reached. For example, if the user selects a temperature for poaching at 160° F., white LED lights 102 will pulse and turn solid from the LED light closest to the user to the top LED light which will then turn green and play an audible alert when the selected temperature is reached. At this point in time, if the user does nothing such as adjust the heat of the burner, or set a new temperature at step 274, the cooking vessel may go to an overheat condition and the module 15 will detect the overheat condition and the green LED light which indicated that the selected temperature was reached would now turn red and an audible alert would again sound to indicate an overheat condition at step 276. If the user does nothing at this point, after a pre-determined period of time, such as two minutes, the unit will proceed to step 278 and since the on/off switch 96 has not been pressed for 1 second, the controller will proceed to step 284 and will time out and power itself off at step 286 after performing another battery test at step 282.

If, on the other hand, at step 274, the user turns down the heat source of the burner and the selected temperature stays within the selected target range, the LED light 102 will remain green at step 276 indicating that the selected temperature is being maintained. The module 15 will continue to monitor the temperature at step 268 and if an overheat condition develops, even after the user has turned down the heat source, the module 15 will again detect this overheat condition and the top LED light 102 will turn red at step 276. After a pre-selected period of time, such as two minutes, the unit will again power itself down as indicated above.

Still further, if, at step 274, the user selects a new temperature setting with dial 85, the sequence of pre-heating the cooking vessel 20 will start over at step 266, the new temperature target parameters will be updated at step 272 and the white LED lights 120 will again begin to pulse from the LED light closest to the user to the top LED light which will again turn solid green when the new selected temperature has been reached. Here again, if the user turns down the heat source and the temperature stays within the selected temperature range, the unit will again shut itself down after a pre-determined period of time as previously explained. If, on the other hand, as previously explained, if the user does nothing to adjust the temperature, or if after adjusting the heat source, an overheat condition still develops, the unit will indicate an overheat condition at step 276 and will again power itself off through steps 278, 284, 282 and 286 as previously explained.

Once the selected temperature has been reached and the proper audio and visual alert has been given to the user at step 276, the user may select to manually turn off the unit by again pressing the on/off switch 96 at step 278. If this happens, the controller will again check to see if the on/off switch has been pressed for at least one second at step 278 and if this is confirmed, the controller will go through the shutdown procedure at step 280 which may include an audible and visual alert notification to the user that the module 15 is shutting down. Once the shutdown procedure has been activated at step 280, the controller will again test the battery at step 282 as explained above at steps 258 and 260 of the startup procedure 250, and the controller will then shut down the cooking appliance 5 at step 286.

If, on the other hand, at step 278, the on/off switch 96 was not pressed for at least one second or some other pre-determined time, and the user has done nothing to adjust the temperature as previously explained by either adjusting the heat source or setting a new temperature or manually shutting down the system as at step 278 and 280, the cooking appliance will, after a predetermined period of time as explained above, timeout at step 284 and will proceed to again test the battery at step 282 and shut down the unit at step 286. If a new temperature has been selected as previously explained, the controller, at step 284 will return to flowchart A and step 266 and will again update the temperature target and tolerances at steps 272 and will again proceed to step 268 as previously explained.

Flowcharts 250 and 265 illustrated in FIGS. 11 and 12 represent just one embodiment as to how the module 15 can be programmed to achieve the desired results and the audio and visual alerts notifying the user of certain attained conditions as explained above. It is recognized and anticipated that other programming is also possible and envisioned so long as a user is notified at least when the selected temperature has been achieved.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cooking appliance comprising:
a cooking vessel having a temperature measuring device associated therewith for measuring the temperature of the cooking vessel;
a handle connected to the cooking vessel and having an end portion; and
a module selectably attachable to the end portion of the handle and including a power supply, said module being electrically coupled to the temperature measuring device and further including a mechanism for selecting at least one selectable pre-determined temperature and a signaling device to indicate when the selectable pre-determined temperature has been reached, said module being selectably removable from the end portion of the handle.

2. The cooking appliance of claim 1 wherein the handle includes a first pin and a second pin, the first pin and the second pin both being located and positioned on an inner surface of the handle;
the module including a first groove and a second groove, the first and second grooves being located and positioned on an outer surface of the module;
the module being insertable into the handle so that the first pin aligns and slides within the first groove and the second pin aligns and slides within the second groove, the module being rotatable within the handle so that both the first and second pins slide within a respective slot associated with the first and second grooves.

3. The cooking appliance of claim 1 wherein the handle includes a heat dissipating member.

4. The cooking appliance of claim 3 wherein the heat dissipating member includes a V-shaped member.

5. The cooking appliance of claim 1 wherein the electrical coupling of the module to the temperature measuring device includes electrical connections extending from the temperature measuring device to a connector assembly in the handle, the connector assembly having at least one electrical connection that mates with and couples to at least one module electrical connection thereby providing power from the module to the temperature measuring device.

6. The cooking appliance of claim 1 wherein the signaling device includes a series of LED lights that will illuminate in a progression from one light to a plurality of lights as the selectable pre-determined temperature is reached.

7. The cooking appliance of claim 6 wherein the signaling device further includes an audio signaling device which emits an audible signal when the selectable pre-determined temperature is reached.

8. The cooking appliance of claim 1 wherein the signaling device further indicates when the selectable pre-determined temperature has been exceeded and an overheat condition exists.

9. The cooking appliance of claim 1 wherein the cooking vessel includes an induction plate, a temperature sleeve plate, and a vessel member, the temperature measuring device being associated with the temperature sleeve plate.

10. The cooking appliance of claim 9 wherein the temperature sleeve plate includes a temperature sleeve cutout, the temperature measuring device being insertable within the temperature sleeve cutout.

11. A cooking appliance comprising:
a cooking vessel;
a temperature measuring device associated with the cooking vessel for measuring the temperature of the cooking vessel;
a handle having an attachment member coupled to the cooking vessel and a heat dissipating member having a V-shaped configuration;
a module being selectably attachable to and removable from the handle and including a power supply, a rotatable dial assembly for selecting a plurality of pre-determined temperatures, at least one signaling device for providing both an audible and a visual alert signal to indicate when a selected pre-determined temperature has been reached, said module being coupled to the temperature measuring device for providing power to the temperature measuring device and for receiving signals from the temperature measuring device indicative of the temperature of the cooking vessel as it heats up to the selected pre-determined temperature.

12. The cooking appliance of claim 11 wherein the handle further includes a handle end portion and a handle tube member, the heat dissipating member being positioned and located between the handle attachment member and the handle end portion and the module being selectively engageable with the handle tube member.

13. The cooking appliance of claim 11 wherein the handle tube member includes a first pin and a second pin positioned and located on an inner surface of the handle tube member;
the module including a first groove and a second groove positioned and located on an outer surface of the module, the first and second grooves each including a slot;
the module being insertable into the handle tube member so that the first pin aligns and slides within the first groove and the second pin aligns and slides within the second groove, the module being rotatable within the handle tube member so that the first pin slides within the slot associated with the first groove and the second pin slides within the slot associated with the second groove.

14. The cooking appliance of claim 13 wherein the first groove and the second groove are of differing widths, the first pin and the second pin being of a different size that corresponds to the width of the first and second grooves.

15. The cooking appliance of claim 11 wherein the handle includes a snap ring connector assembly coupled to the temperature measuring device, the snap ring connector assembly having at least one snap ring electrical connection that mates with at least one module electrical connection thereby providing power from the module to the temperature measuring device.

16. The cooking appliance of claim 15 wherein the snap ring connector assembly is coupled to the temperature measuring device through an interior portion of the handle.

17. The cooking appliance of claim 11 wherein the cooking vessel includes an induction plate, a temperature sleeve plate, and a vessel member, the temperature sleeve plate including a temperature sleeve cutout, the temperature measuring device being insertable within a sleeve member and the sleeve member being insertable within temperature sleeve cutout.

18. The cooking appliance of claim 11 wherein the at least one signaling device includes a series of LED lights and an audio signaling device.

19. The cooking appliance of claim 18 wherein the series of LED lights illuminate in a progression from one light to a plurality of lights as the selected pre-determined temperature is approached.

20. The cooking appliance of claim 18 wherein the at least one signaling device emits an audible signal when the selected pre-determined temperature is reached.
